(19) United States
(12) Patent Application Publication
(10) Pub. No.: US 2006/0064309 A1
(43) Pub. Date: Mar. 23, 2006

(54) Method and article of manufacture for promotion and memorialization of a person's life and/or career or the life of an organization

(76) Inventor: Maximus Charles Leonitta King, Fresno, CA (US)

Correspondence Address: VESNA N. RAFATY, 18926 CAMPBELL ROAD, DALLAS, TX, 75252, US

(21) Appl. No.: 10/944,362

(22) Filed: Sep. 18, 2004

(51) Int. Cl. G06Q 99/00; G06Q 30/00

(52) U.S. Cl. 705/1; 705/26

(57) ABSTRACT

A method and article for the promotion, celebration, and memorialization of the life and/or career of an individual or the life of an organization comprising an article of manufacture which has embodied on its surface images of selected indicia from different periods in the life and/or career of the individual or the life of the organization, with selected indicia grouped by period, and indicia from different periods being separated by a visible demarcation means on the article of manufacture.

### COPYRIGHT NOTICE

A portion of the disclosure of this patent document contains material to which a claim for copyright is made. The copyright owner has no objection to the facsimile reproduction by anyone of the patent document or the patent disclosure, as it appears in the U.S. Patent & Trademark Office patent file or records, but reserves all other copyright rights whatsoever.

### BACKGROUND OF THE INVENTION

The present invention relates generally to the field of marketing, advertising, and promotion of an individual's life and/or career via merchandising. More specifically, the present invention is directed to a method of promoting, advertising, informing about, and/or memorializing an individual's life and/or career via articles of manufacture which embody, on a single article of manufacture, various indicia from multiple delineated periods of time in that person's life and/or career. The present invention is also directed to articles of manufacture, such as but not limited to articles of clothing, which contain selected indicia from an individual's life and/or career displayed in organized and demarcated timelines from an individual's life and/or career.

Use of articles of clothing as well as other merchandising items, such as toys, bags, flags, or similar items, to advertise the career of and promote loyalty to person(s) of celebrity is not new. Jerseys and T-shirts, for example, which depict images of professional athletes or which mimic the professional uniforms of the athlete are not new. Similarly, band shirts depicting images of band members and/or logos of service marks of the band name are known in the prior art as methods of promoting and celebrating the careers of artists. T-shirts which have printed on them an artist's tour schedule (dates and cities; tour sponsors) are also known.

U.S. Pat. No. 6,176,520, issued to Himmelwright, is directed to a method and article for advertising and promoting an institution or organization via a flag or article of clothing which contains certain specified indicia identifying or describing that institution or organization, including a textual expression of allegiance to said institution or organization, and also including on said flag or article of manufacture an area which is made to enable retention of marks from a writing instrument.

However, no known prior art is directed to a method, and article of manufacture intended to be worn, carried, or displayed by a consumer, for promoting, advertising, celebrating, and memorializing a person's life and/or career by providing text and/or images, herein collectively referred to as either “indicia” or “content” from that person's life and/or career, on a single article of manufacture, where the indicia reflect, belong to or refer to a specific pre-defined period of time in that person's life and/or career, where more than one such period of time is depicted on a single article of manufacture, and where a demarcation between periods of time is made so that the consumer knows what indicia belong to the same period of time. In short, no known prior art is directed to a marketing or advertising method which utilizes an article of merchandise which embodies on the surface of that article a timeline-type record of that person's career and/or life via pre-selected, period of time-allocated, and segregated indicia.

Note that “timeline” is used herein broadly to refer to periods of time or stages of an individual's life and/or career. Thus, by way of example and not by way of limitation, a professional athlete's career may be depicted in three timelines which correspond roughly to the following periods or stages: the athlete's high school sports career, college sports career, and professional sports career. The span of dates and times covered by any selected timeline in not significant under this invention. Those who practice this invention will find that there is virtually limitless choice in the selection of timelines to be depicted under the disclosed invention.

### SUMMARY OF THE INVENTION

What is needed is a merchandising method for promoting a person's career which informs the consumer, via indicia depicted on an article of clothing, about certain events, accomplishments, awards, and/or facts from that person's life, where the content is organized into pre-selected timelines depicted on portions of the article of clothing and where the consumer of that article of clothing will be able to recognize the line of demarcation between content from different timelines.

What is needed is a merchandising method for promoting a person's career which celebrates, on a single article of clothing, via text and/or images, selected events, accomplishments, achievements, and accolades from that person's career organized in pre-selected timelines depicted on delineated portions of the article of manufacture.

What is needed is a merchandising method which promotes loyalty to and familiarity with an individual, such as a professional athlete, professional musician, actor, or other celebrity, by displaying on a single article of manufacture, such as an article of clothing, an “album” of significant milestones and achievements of that individual where the consumer/fan will know that each “page” (referring to a collection of selected indicia from the same period), figuratively speaking, of that “album” belongs to a different, demarcated period in the life of that individual.

What is needed is a merchandising method which enables the consumer to quickly and readily associate content depicted on certain portions of the article of merchandise with specific timelines or periods from a person's (e.g., celebrity's) life and/or career.

While the preferred embodiment of the disclosed invention for an article of manufacture is directed to an article of clothing such as a jersey or T-shirt, it will be obvious to an individual having ordinary skill in the relevant art that other articles of merchandise, such as but not limited to a sports bag or tote bag, shirt, belt, hat, umbrella, article of bedding, pants, flag or banner, socks, underwear, pajamas, may be used to practice the disclosed invention. Such other articles of manufacture, however, shall have adequate space for placement of indicia from multiple timelines in a way that the individual item of indicia can be perceived by the consumer.

The individual items that comprise the indicia selected under the different timelines are virtually limitless in their scope of subject matter. For example, under the professional period timeline of a professional football player, selected content might include images of that player's professional jersey, an accolade, images of that player talking with fans, a newspaper headline celebrating his team's victory, image of the player embracing his daughter on the field at the end of a game. The point is that the content for any given timeline is selected based on the message(s) the designer of that article wishes to convey.

Moreover, the number of items of indicia or content selected for any given timeline is limited only by the available space on the article of manufacture and by the desired level of clarity, emphasis, importance, visibility, and/or readability desired for that particular item of content.

The term “content” and the term “indicia” used herein refers very broadly to text, alphabets, logos, trademarks, signatures, symbols, numbers, dates, graphs, formulae, quoted speech, banners, flags, shapes, characters, graphics, data tables, art, cartoons, document pages, portraits, photographs and other types of images, and any other visual content which may be caused to be embodied on some article of merchandise in order to convey some information to the consumer.

The term “designer” as used in this disclosure refers to any individual who wants to practice this invention and makes decisions regarding the content to be used and the timelines to be depicted on the article of merchandise or article of manufacture.

The term “article of merchandise” herein refers broadly to any consumer item, including articles of clothing, which can be caused to embody/carry/display text and/or images on its surface(s) such that that the article of merchandise becomes in part an advertising vehicle for that content.

### BRIEF DESCRIPTION OF THE DRAWINGS

FIG. 1 is a front view of a jersey according to the preferred embodiment for an article of manufacture for promoting the career a professional football player.

FIG. 2 is a front view of a jersey according to the preferred embodiment for an article of clothing celebrating the career of a professional hockey player.

FIG. 3 is a color printed image of a representative copyrighted design for a T-shirt for a preferred embodiment of the disclosed invention for a television celebrity

### DETAILED DESCRIPTION OF THE DRAWINGS

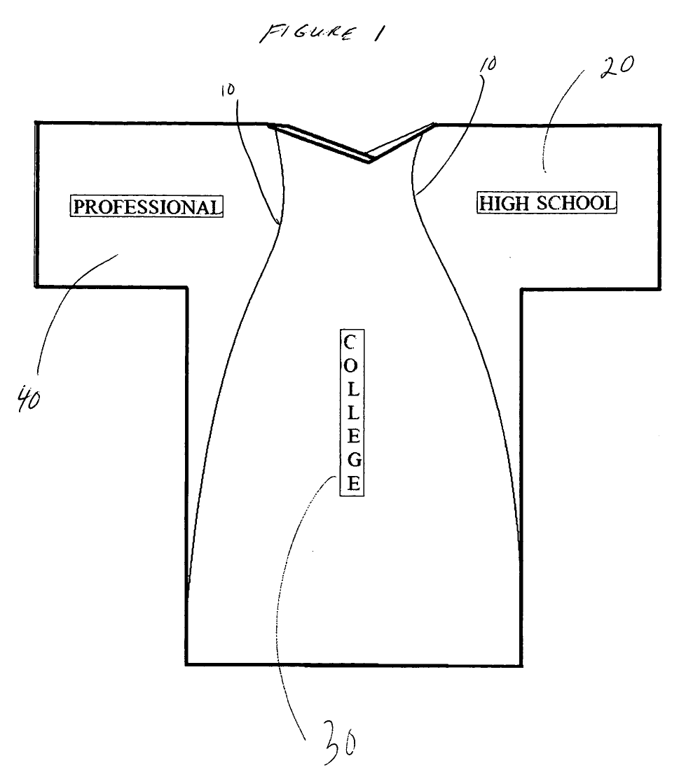

FIG. 1 shows a preferred embodiment for an article of clothing, namely a jersey, promoting, celebrating, and memorializing the career of a professional football player. The three different timelines on the T-shirt are demarcated or separated by lines 10 which may be printed or stitched on the jersey. The three timelines represented are the high school career 20, the college sports career 30, and the professional sports career 40. The various indicia of content for each timeline are not shown in FIG. 1 because the purpose of FIG. 1 is simply to illustrate for a preferred embodiment the type of demarcation of timelines, the number and type of timelines, and the portions of the jersey where indicia from any given selected timeline are applied.

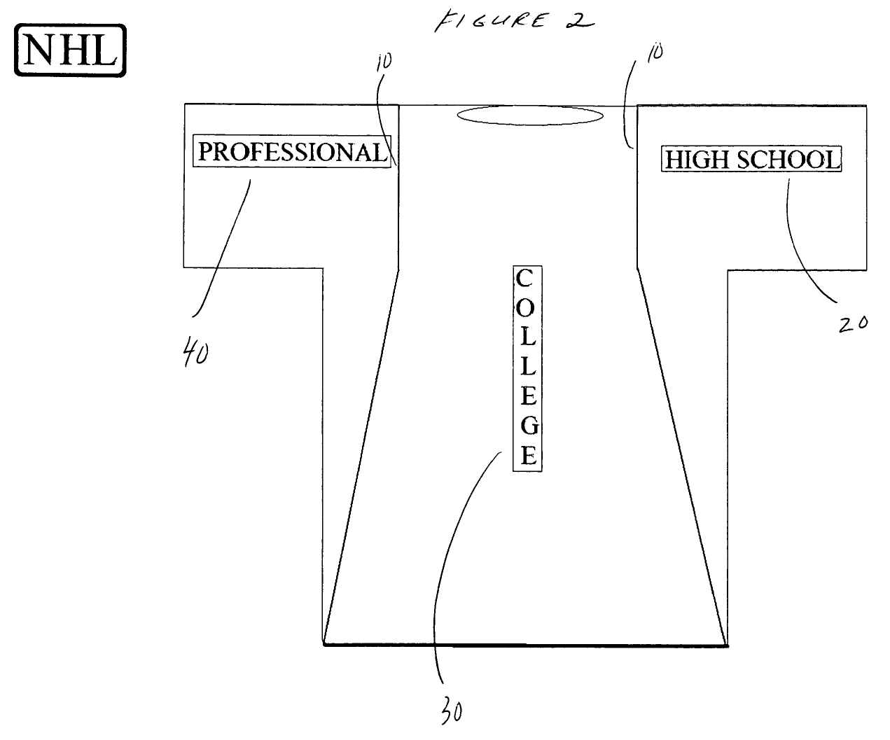

Similarly, FIG. 2 shows a preferred embodiment for a jersey promoting, celebrating, and memorializing the career of a professional hockey player. Again, the chosen timelines are the player's high school 20, college 30, and professional 40 (National Hockey League, NHL) life. Again, items of indicia are not shown. The visible demarcation means between periods is accomplished via curved lines 10 which may be printed or stitched or applied via any other suitable manufacturing method known.

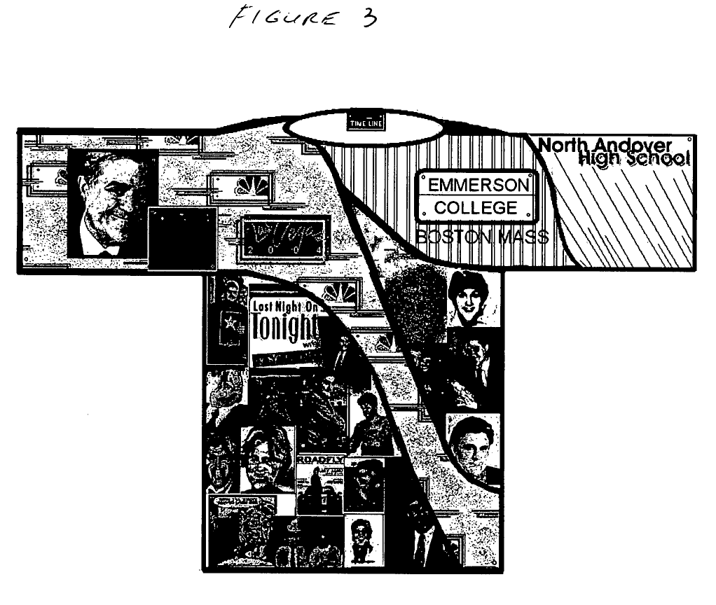

FIG. 3 shows a color image of a copyrighted design for a T-shirt celebrating and memorializing the life and career of Jay Leno, a television personality. Timeline Creations, Inc., a Nevada corporation, reserves all copyrights in the design as shown. Note that the visible demarcation means between timelines is accomplished via black curved lines which may be stitched or printed on the fabric of the T-shirt.

The applicant has specified designs (drawings not shown) similar to FIGS. 1 and 2 for preferred embodiments for T-shirts and/or jerseys for each of the other major professional sports such as but not limited to basketball, baseball, and soccer.

The demarcation between collections of indicia from different timelines can be effected in any of a number of ways using any suitable manufacturing method known, all of which are considered to be within the scope of the disclosed invention. For illustration purposes only, and not by way of limitation, demarcation can be effected via one or a combination of straight line(s), curved line(s), vertical line(s), broken lines, horizontal line(s), slash (slashes), row(s) or column(s) of characters, and choice of background colors. The purpose of the demarcation is to convey to the consumer that the collections of indicia belong to different periods.

The designer's choices for allocation of a specific timeline to a unique and consistent part of the article of clothing and article of merchandise are too numerous to name and are all considered to be within the scope of this disclosure. Thus, for example and not by way of limitation, if the article of clothing is a T-shirt, sweatshirt, or jersey, a few of the possible choices for placement of any specific timeline are the right sleeve, left sleeve, back panel, front panel, collar, left portion, and the right section, middle section, and left section of the front panel.

Under the preferred embodiment of the method under the disclosed invention where the article of manufacture is an article of clothing, the designer will consistently place a particular timeline's content in the same part or portion of every such item of clothing manufactured and distributed to the public. Hence, for example and not by way of limitation, where the designer is promoting an athlete using T-shirts, the designer may place indicia from the athlete's college sports career on the front panel of the T-shirt, indicia from the athlete's high school sports career on the left sleeve, and indicia from the athlete's professional sports career on the right sleeve and the back panel of the T-shirt. And, for every T-shirt manufactured and distributed to the public which promotes that athlete, the designer would similarly place the indicia from the different selected periods. Moreover, under the preferred method, the designer may choose the same allocation of periods to specific parts of the shirt for every T-shirt designed, manufactured and sold promoting every other athlete selected to be promoted. This marketing strategy enables purchasers, over time, to readily “read” the article of clothing and know at a glance which timelines are represented by any given content. This is a useful promotion strategy because it quickly and readily informs the consumer about periods in the life of the celebrity and leaves the consumer less frustrated because the consumer need not conduct research in order to allocate the different collections of indicia to a particular timeline or period in the career of the celebrity.

It will be obvious that the disclosed method is equally applicable to promotion and celebration of the life stages of an organization. Thus, as an illustration and not by way of limitation, a designer may select indicia from the following specific timelines in the life of an organization: pre-formation, charter, operation, and dissolution and/or wind-up.

I claim:

1. A method of promoting, advertising, and/or memorializing an individual and/or the life and/or career of an individual, comprising the steps of:
providing an article of manufacture;
selecting indicia from more than one period in the life and/or career of the individual;
organizing the selected indicia by the period in the life and/or career of the individual;
authorizing the use of the selected indicia on the article of manufacture or securing appropriate clearances, authorizations, licenses, and/or approvals to use the selected indicia on the article of manufacture;
causing said selected indicia to be incorporated into or embodied on the article of manufacture in such a way that the selected indicia from the same period in the life and/or career of the individual are separated by a visible demarcation means, embodied on the article of manufacture, from the selected indicia from a different period in the life and/or career of the individual, and distributing, offering for sale, and/or selling said article of manufacture to the public.

2. A method as in claim 1 where the article of manufacture is an article of clothing.

3. A method as in claim 1 where the article of manufacture is a T-shirt.

4. A method as in claim 1 where the article of manufacture is a jersey.

5. A method as in claim 1 where the article of manufacture is a shirt.

6. A method as in claim 1 where the article of manufacture is an article of lingerie.

7. A method as in claim 1 where the article of manufacture is a sports bag.

8. A method as in claim 1 where the article of manufacture is a cap.

9. A method as in claim 1 where the article of manufacture is a hat.

10. A method as in claim 1 where the article of manufacture is a toy.

11. A method as in claim 1 where the article of manufacture is a belt.

12. A method as in claim 1 where a single indicium is selected and used for each period.

13. A method as in claim 1 where the periods of time in the life and/or career of the individual comprise at least two of the following: the professional sports life, college sports life, high school sports life, and retirement or post-professional sports life of said individual.

14. A method as in claim 1 where the periods of time in the life and/or career of the individual comprise at least two of the following: school theater career, community theater career, professional theater career, independent film career, motion picture career, and Hollywood career.

15. A method as in claim 1 where the number of periods of time in the life and/or career of the individual is a number between two (2) and one thousand (1,000) inclusive.

16. A method as in claim 1 where the selected indicia comprise any one of the following: a logo, a signature, words of text, an accolade, a trademark, an image of a person or persons, an image of an animal, an image of a uniform, jersey numbers, an image of an award, trophy, document, or certificate.

17. A method as in claim 1 which further comprises the step of displaying the article of manufacture in a public place.

18. A method as in claim 1 which further comprises the step of wearing, displaying, or carrying the article of manufacture on one's person in a public place.

19. A method as in claim 1 where the demarcation means comprises at least one of the following: unique background color for indicia from each different period in life and/or career of the individual, a stitched straight or curvilinear line, a printed straight or curvilinear line, a slash, and/or a series of slashes.

20. A method as in claim 1 where the article of manufacture is an article of clothing and further comprising the step of placing a single unit of the article of clothing in a container comprising a transparent lid and then distributing, selling, and offering said container packed with a single unit of the article of clothing for sale to the public.

21. A method as in claim 1 where the article of manufacture is an article of clothing and further comprising the step of causing the selected indicia (or indicium) for any given period to be incorporated into or embodied on a specific part of the article of clothing on each said article of clothing distributed, sold, and/or offered for sale to the public.

22. An article of manufacture for promoting, advertising, and/or memorializing an individual and/or the life and/or career of an individual comprising selected indicia or images of selected indicia from more than one period of time in the life and/or career of the individual:
said indicia and/or said images being incorporated into or embodied on the surface of the article of manufacture via any suitable manufacturing means such that they are visible to the consumer during normal intended use of the article of manufacture;
said indicia and/or said images further being organized by period of time in the life and/or career of the individual and each said period being separated from each other period by way of a visible demarcation means embodied on the surface of the article of manufacture.

23. An article of manufacture as in claim 22 where the article of manufacture is an article of clothing.

24. An article of manufacture as in claim 22 where the article of manufacture is a T-shirt.

25. An article of manufacture as in claim 22 where the article of manufacture is a jersey.

26. An article of manufacture as in claim 22 where the where the selected indicia comprise one or more of the following: a logo, a signature, words of text, an accolade, a trademark, an image of a person or persons, an image of a uniform, parts of a uniform, professional jersey numbers, an image of an award, trophy, document, or certificate.

27. An article of manufacture as in claim 22 where a single indicium is selected from each period.

28. An article of manufacture as in claim 22 where the demarcation means comprises at least one of the following: unique background color for indicia from each different period in life and/or career of the individual, a stitched straight or curvilinear line, a printed straight or curvilinear line, a slash, a series of slashes, row(s) or column(s) of characters.

29. An article of manufacture as in claim 22 where the periods in the life and/or career of the individual comprise at least two of the following: high school sports career, college sports career, professional sports career, retirement or post-professional life of the individual.

30. An article of manufacture as in claim 22 where the article of manufacture is a T-shirt, shirt, or jersey comprising a front side, a back side, a left sleeve, and a right sleeve, where the periods in the life and/or career of the individual comprise the high school sports career, college sports career, and the professional sports career, and where the indicia or images of indicia from the college sports career are incorporated into or embodied substantially on the front side of the T-shirt, shirt or jersey, the indicia or images of indicia from the high school sports career are incorporated into or embodied substantially on the left sleeve of the T-shirt, shirt or jersey; the indicia or images of indicia from the professional sports career are incorporated into or embodied substantially on the right sleeve of the T-shirt, shirt or jersey, and the indicia or images of indicia from either the professional sports career or the college sports career are incorporated into or embodied substantially on the back side of the T-shirt, shirt or jersey.

31. An article of manufacture as in claim 22 where said indicia or images of indicia from any given period of time in the life and/or career of the individual are incorporated into or embodied on a dedicated part or portion of the article of manufacture on every such article of manufacture.

32. An article of manufacture for promoting, advertising, and/or memorializing the life of an organization comprising indicia or images of indicia from more than one period of time in the life of the organization:
said indicia or images of indicia being incorporated into or embodied on the article of manufacture so that they are visible to the consumer during normal intended use of the article of manufacture;
said images further being organized by period of time in the life of the organization and each said period being separated from each other period by way of a visible demarcation means embodied on the surface of the article of manufacture.

33. A method for promoting, advertising, and/or memorializing the life of an organization comprising the steps of:
providing an article of manufacture;
selecting indicia from more than one period in the life of the organization;
organizing the selected indicia by the period in the life of the organization;
authorizing the use of the selected indicia on said article of manufacture or securing appropriate clearances, authorizations, licenses, and/or approvals to use the selected indicia on said article of manufacture;
causing said selected indicia to be incorporated into or embodied on the article of manufacture in such a way that the selected indicia from the same period in the life of the organization are separated by a visible demarcation means, embodied on the article of manufacture, from the selected indicia from a different period in the life of the organization, and
distributing, offering for sale, and/or selling said article of manufacture to the public.
